(19) United States
(12) Patent Application Publication
(10) Pub. No.: US 2018/0025062 A1
(43) Pub. Date: Jan. 25, 2018

(54) DATA SEARCHING APPARATUS

(71) Applicant: Jin Hyuk Choi, Daejeon (KR)

(72) Inventor: Jin Hyuk Choi, Daejeon (KR)

(73) Assignee: INFORIENCE INC., Daejeon (KR)

(21) Appl. No.: 15/347,711

(22) Filed: Nov. 9, 2016

(30) Foreign Application Priority Data
Jul. 22, 2016 (KR) 10-2016-0093155

(51) Int. Cl. G06F 17/30; G06N 99/00; G06Q 30/02

(52) U.S. Cl. CPC G06F 17/30551; G06F 17/30554; G06F 17/30572; G06F 17/30598; G06Q 30/0283; G06N 99/005

(57) ABSTRACT

The present disclosure relates to a data searching apparatus. The data searching apparatus includes: a memory configured to store a first time-series data and a second time-series data which are different from each other; and a processor configured to be able to access the memory, wherein the processor derives a first matching data which is a part of a first search target time-series data that is matched to a first pattern of the first time-series data existing in a setting section, and derives a second matching data which is a part of a second search target time-series data, which is different from the first search target time-series data, that is matched to a second pattern of the second time-series data existing in the setting section.

### CROSS-REFERENCE TO RELATED APPLICATIONS

This application claims priority under 35 U.S.C. §119 from Korean Application No. 10-2016-0093155 filed on Jul. 22, 2016, the subject matter of which is incorporated herein by reference.

### BACKGROUND OF THE INVENTION

### Field of the Invention

The present disclosure relates to a data searching apparatus.

### Description of the Related Art

Since anybody may collect data through a web, a smart phone, an IoT sensor, and the like, the diversification and personalization of data source has been achieved. In order to support this trend, data analysis algorithm has been used in the form of open-source and platform has been formed to provide service. In addition, it is possible to apply algorithm even in the case of not having a specialized technical knowledge.

However, even if data and algorithm are prepared, not everyone may easily utilize the data. Technical knowledge and experience are required to process the data, search key information included in the data, and apply data mining or machine learning algorithm, but not everyone has such knowledge and experience.

In addition, in the future, as much as expert knowledge on the data or the algorithm, the importance of the experiential knowledge on the environment and condition in which data is generated, the personal disposition, and the knowhow for the data utilized by applying specific parameter for specific algorithm would be even greater.

In addition to the data, it is a very important factor in implementing an artificial intelligence service to perform the process for collecting the data on a large scale.

Therefore, everyone should be able to easily borrow the ability of an experienced hand having an empirical knowledge on the data or an expert having a professional skill on the data analysis so that everyone may be able to take advantage of their own data maximally. On the other hand, it is necessary that experienced hands and experts may have the opportunity to generate revenue by utilizing their knowledge and experience through such a process.

### SUMMARY OF THE INVENTION

The present disclosure has been made in view of the above problems, and provides a data searching apparatus for searching data of a pattern desired by a user from search target time-series data.

The present disclosure further provides a data searching apparatus for classifying comment allocated to a matching section.

The present disclosure further provides a data searching apparatus for computing comment, setting section, and the price of classification tag list.

The present disclosure further provides a data searching apparatus for classifying newly inputted analysis target time-series data in accordance with classification tag.

The present disclosure further provides a data searching apparatus for allocating comment in a section or a time selected by a user.

The present disclosure further provides a data searching apparatus for computing comment, selection section or selection time, and the price of classification tag list.

In accordance with an aspect of the present disclosure, a data searching apparatus includes: a memory configured to store a first time-series data and a second time-series data which are different from each other; and a processor configured to be able to access the memory, wherein the processor derives a first matching data which is a part of a first search target time-series data that is matched to a first pattern of the first time-series data existing in a setting section, and derives a second matching data which is a part of a second search target time-series data, which is different from the first search target time-series data, that is matched to a second pattern of the second time-series data existing in the setting section. The first search target time-series data and the second search target time-series data are at least part of the first time-series data and the second time-series data respectively. The first search target time-series data and the second search target time-series data are different from the first time-series data and the second time-series data. The processor allocates an externally input comment to a matching section in which the first matching data and the second matching data exist, and classifies the comment according to classification tag included in the comment. The processor generates a comment list for the comment to link to the classification tag, and generates a classification tag list for the classification tag. The processor receives and allocates a score for at least one of the setting section, the classification tag, and the comment from one or more user terminals, calculates the number of citations of the comment when the comment is cited in other comment, and computes a price for the comment according to the score and the number of citations of the comment. The processor generates a data vector formed of a first feature of the first matching data and a second feature of the second matching data, and classifies the first analysis target time-series data and the second analysis target time-series data according to the classification tag by applying the first analysis target time-series data and the second analysis target time-series data to machine learning model in accordance with the data vector. The processor applies the first analysis target time-series data and the second analysis target time-series data to the machine learning model without a derivation of matching data and a comment allocation. The first feature and the second feature are a data value sampled at the same point of time from the first matching data and the second matching data respectively. The first feature and the second feature include each slope of the segmented first matching data and second matching data existing in the same section.

In accordance with another aspect of the present disclosure, a data searching apparatus includes: a memory configured to store a time-series data; and a processor configured to be able to access the memory, wherein the processor allocates an externally input comment to a partial section or partial time of the time-series data, and classifies the comment according to classification tag included in the comment. The processor generates a comment list for the comment to link to the classification tag, and generates a classification tag list for the classification tag. The processor receives and allocates a score for at least one of the classification tag and the comment from one or more user terminals, calculates the number of citations of the comment when the comment is cited in other comment, and computes a price for the comment according to the score and the number of citations of the comment. The processor generates a data vector formed of feature of the time-series data to which the comment is allocated, and classifies another time-series data by applying the another time-series data to machine learning model in accordance with the data vector. The processor applies the another time-series data to the machine learning model without a comment allocation.

### BRIEF DESCRIPTION OF THE DRAWINGS

The objects, features and advantages of the present disclosure will be more apparent from the following detailed description in conjunction with the accompanying drawings, in which:

FIG. 1 illustrates a data searching apparatus according to an embodiment of the present disclosure;

FIG. 2 illustrates an example of a first time-series data, a second time-series data, a first search target time-series data, and a second search target time-series data;

FIG. 3 illustrates an example of a comment allocated to a matching section;

FIG. 4 illustrates an example of classification tag list;

FIG. 5 and FIG. 6 are diagrams illustrating a process for generating a data vector;

FIG. 7 to FIG. 9 illustrate a machine learning model; and

FIG. 10 to FIG. 12 illustrate a comment allocated to a section selected by a user.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

The terms and words used in the following description and claims are not limited to the bibliographical meanings, but, are merely used by the inventor to enable a clear and consistent understanding of the present disclosure. It is to be understood that the singular forms “a,” “an,” and “the” include plural referents unless the context clearly dictates otherwise.

In the present disclosure, the terms such as “include” and/or “have” may be construed to denote a certain feature, number, step, operation, constituent element, component or a combination thereof, but may not be construed to exclude the existence of or a possibility of addition of one or more other features, numbers, steps, operations, constituent elements, components or combinations thereof.

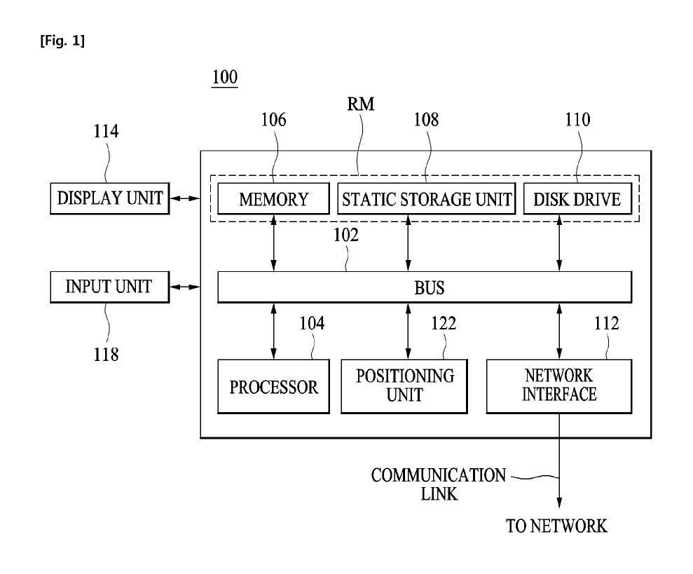

FIG. 1 illustrates a data searching apparatus according to an embodiment of the present disclosure. Referring to FIG. 1, the data searching apparatus according to an embodiment of the present disclosure may include a memory 106 and a processor 104.

The data searching apparatus according to an embodiment of the present disclosure may include a bus 102 or other communication mechanism for communicating information. Such a bus 102 or other communication mechanism may interconnect the processor 104, a computer readable recording medium (RM), a network interface 112 (e.g., a modem or an ethernet card), a display unit 114 (e.g., a CRT or a LCD), an input unit 118 (e.g., a keyboard, a keypad, a virtual keyboard, a mouse, a trackball, a stylus, a touch sensing means, etc.), and/or subsystems.

The computer-readable recording medium (RM) may include a memory 106 (e.g., RAM), a static storage unit 108 (e.g., ROM), a disk drive 110 (e.g., HDD, SSD, an optical disk, a flash memory drive, etc.), but it is not limited thereto. At this time, the disk drive may be a non-transitory recording medium. The optical disc may be CD, DVD, Blu-ray disc, but it is not limited thereto.

The data searching apparatus according to an embodiment of the present disclosure may include one or more disk drives 110. Further, as shown in FIG. 1, together with the processor 104, the disk drive 110 may be provided to a housing 120.

However, alternatively, it may be installed remotely to perform a remote communication with the processor 104. In addition, a database having one or more disk drives may be included.

The recording medium (RM) may store an operating system, a driver, an application program, a data, and a database required for the operation of the data searching apparatus according to an embodiment of the present disclosure.

The display unit 114 may display operation of the data searching apparatus according to an embodiment of the present disclosure and a user interface.

The processor 104 may be a CPU, a microcontroller, a digital signal processor (DSP), or the like, but it is not limited thereto, and may control the operation of the data searching apparatus according to an embodiment of the present disclosure.

The processor 104 may access the recording medium (RM) and may perform data search, comment allocation, processing of classification tag, machine learning, etc. which are described later by executing one or more sequences of instructions stored in the recording medium (RM).

These instructions may be read into the memory 106 from other computer readable medium such as the static storage unit 108 or the disk drive 110. In other embodiments, instead of the software instructions for implementing the present disclosure, a hard-wired circuitry embedded in hardware may be used in combination with software instructions.

Logic may be encoded in the computer readable recording medium (RM) which may refer to an arbitrary medium that participates in providing instructions to the processor 104. Such a recording medium (RM) may include a non-volatile recording media, a volatile recording medium, but may take many forms which are not limited thereto.

The processor 104 may display the operation of the data searching apparatus and the operation of user interface on the display unit 114 by communicating with a hardware controller for the display unit 114.

In one embodiment, the computer-readable recording medium (RM) may be a non-transient. In various embodiments, the non-volatile recording medium (RM) may include an optical or magnetic disk, e.g., a disk drive 110, and the volatile recording medium may include a dynamic recording medium such as a system memory 106. Transmission media including wires that include the bus 102 may include coaxial cables, copper wire, and optical fibers.

In one example, transmission media may take the form of the radio wave and the sound waves or light wave which is generated in infrared data communications.

Some common forms of the computer readable recording medium (RM) may include, for example, a floppy disk, a flexible disk, a hard disk, a magnetic tape, any other magnetic medium, CD-ROM, any other optical medium, punch cards, a paper tape, any other physical medium with patterns of holes, RAM, PROM, EPROM, FLASH-EPROM, any other memory chip or cartridge, and any other medium that is adapted to be read by a carrier wave or a computer.

In various embodiments of the present disclosure, the execution of instruction sequences for implementing the present disclosure may be performed by the data searching apparatus according to an embodiment of the present disclosure. In various other embodiments of the present disclosure, a plurality of computing devices 100 which are coupled to network (e.g., other wired or wireless networks including LAN, WLAN, PTSN and/or remote communications, mobile and cellular phone networks) by a communication link 124 may perform instruction sequences for implementing the present disclosure by cooperating with each other.

The data searching apparatus according to an embodiment of the present disclosure may transmit and receive instructions that include messages, data, information, and one or more programs (i.e., application code) via the communication link 124 and a network interface 112.

The network interface 112 may include a separate or integrated antenna for enabling transmission and reception via the communication link 124. The received program code may be executed by the processor 104 when it is received, and/or may be stored in the disk drive 110 or some other non-volatile storage so as to execute.

Next, the operation of the data searching apparatus according to an embodiment of the present disclosure is described with reference to the drawings.

The memory 106 may store first time-series data and second time-series data which are different from each other. The first time-series data and the second time-series data may include information on various data values based on time.

For example, the first time-series data and the second time-series data may be information on a sensing value corresponding to output time by a sensor, or information on stock price index for a specific company or a stock market based on time.

Further, the first time-series data and the second time-series data may be outputted respectively from the different sensors sensing the same factor, and may be related to different factors (e.g., the temperature of sea surface and the movement route of storm, the temperature and the growth amount of crops, etc.).

The processor 104 is able to access the memory 106. Accordingly, the processor 104 may read the first time-series data and the second time-series data.

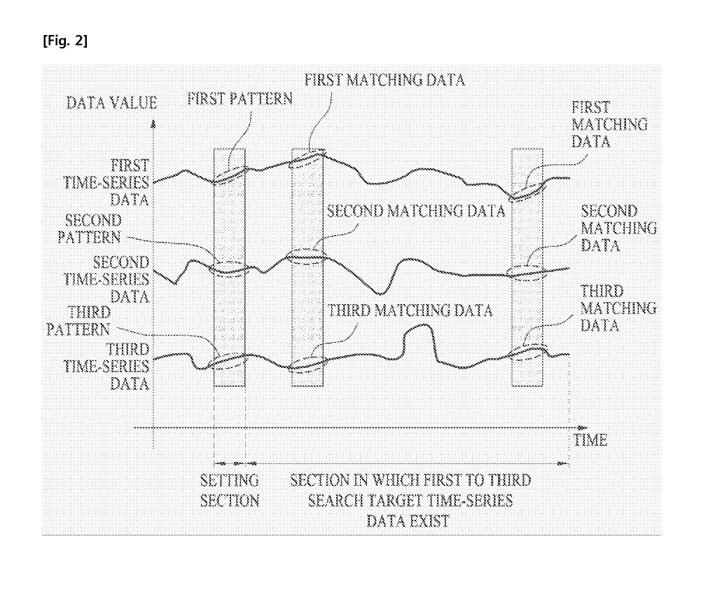

FIG. 2 illustrates an example of the first time-series data, the second time-series data, a first search target time-series data, and a second search target time-series data. In FIG. 2, the horizontal axis may correspond to time and the vertical axis may correspond to value of each time-series data.

The processor 104 may derive a first matching data which is part of the first search target time-series data that is matched to a first pattern of the first time-series data existing in a setting section.

In addition, the processor 104 may derive a second matching data which is part of the second search target time-series data, different from the first search target time-series data, that is matched to a second pattern of the second time-series data existing in the setting section.

That is, the processor 104 may search data that is matched to the pattern of different time-series data existing in the same setting section from the first search target time-series data and the second search target time-series data.

To this end, the processor 104 may derive the first matching data and the second matching data by searching data which is identical with or similar to a plurality of patterns of the setting section while windowing the plurality of patterns of the setting section with respect to a total section of a plurality of different search target time-series data. A default value may be provided as an acceptable error rate, and the default value may be changed.

To this end, the processor 104 may perform data sampling in the setting section and may search data which is identical with or similar to the order of sampled data and the data values.

The processor 104 may perform search operation for the first search target time-series data and the second search target time-series data, but it is not limited thereto, and, as shown in FIG. 2, may perform search operation for three or more different search target time-series data.

As described above, the data searching apparatus according to an embodiment of the present disclosure may search data which is identical with or similar to the pattern of setting section among different time-series data.

For example, assuming that the first time-series data to the third time-series data are temperature, humidity, and growth amount of crop according to time respectively, when a user inputs a section which is highly related with the temperature, the humidity, and the growth amount of crop as the setting section, the data searching apparatus may search a part which is identical with or similar to the pattern of the temperature, the humidity, and the growth amount of crop in the setting section from a plurality of search target data. Accordingly, the user may find a highly related section easily.

Meanwhile, as shown in FIG. 2, the first search target time-series data and the second search target time-series data may be at least part of the first time-series data and the second time-series data, respectively.

Alternatively, unlike FIG. 2, the first search target time-series data and the second search target time-series data may be different from the first time-series data and the second time-series data, respectively.

For example, the first time-series data and the second time-series data may be data outputted by a temperature sensor 1 and a humidity sensor 1, and the first search target time-series data and the second search target time-series data may be data outputted by a temperature sensor 2 and a humidity sensor 2.

Accordingly, user may determine whether a part which is identical with or similar to the pattern of the setting section among data of the temperature sensor 1 and the humidity sensor 1 exists in the data outputted by the temperature sensor 2 and the humidity sensor 2.

The setting of the setting section in the above description may be achieved through a query.

The processor 104 may perform search operation after smoothing the plurality of search target time-series data to some extent through a normalization filter or a mean filter before search.

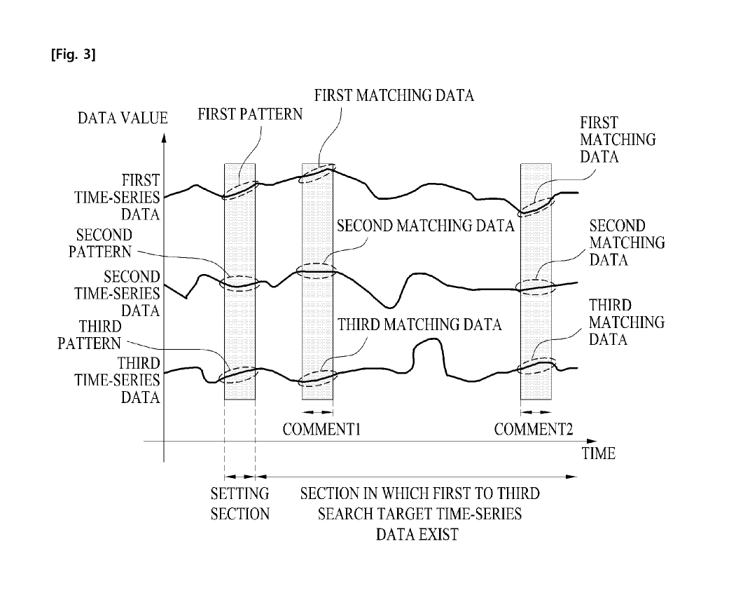

Meanwhile, as shown in FIG. 3, the processor 104 may allocate a comment inputted from the outside to matching section in which the first matching data and the second matching data exist. User may input a comment of matching section through his/her own terminal or the input unit 118. The comment may be the interpretation, opinion, or note of the user on the matching section, but it is not limited thereto.

The terminal may be communicatively connected to the data searching apparatus according to an embodiment of the present disclosure, and may be PC, a tablet, a smart phone, or a laptop but it is not limited thereto.

At this time, comment may include a classification tag, and the processor 104 may classify comment according to the classification tag included in the comment. For example, user may input comment ‘Take care when another matching section occurs within #one minute after a first matching section’.

At this time, the comment may include classification tag such as #one minute, and the classification tag in the embodiment of the present disclosure may be a hash tag, but it is not limited thereto.

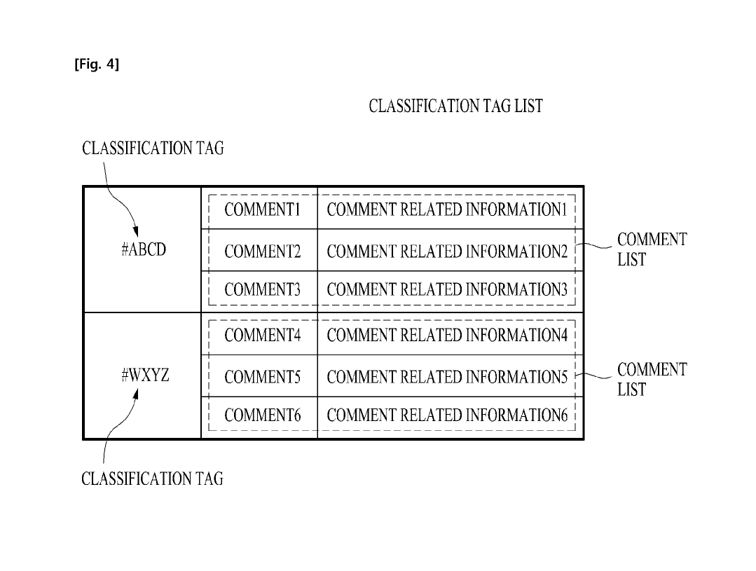

As shown in FIG. 4, the processor 104 may generate a classification tag list sorted by classification tag, and may store such a classification tag list in the recording medium (RM).

That is, the processor 104 may generate a comment list for comment and may link to the classification tag, and generate a classification tag list for classification tag. The comment list may be generated for each classification tag, and may also include comment related information together with comment.

That is, comment 1 to comment 3 may include a classification tag #ABCD, and comment 4 to comment 6 may include a classification tag #WXYZ.

Comment related information may include the title of comment, the ID of comment writer, the writing time, the beginning position and the end position of a matching section to which comment is allocated, and the maximum, minimum and average value of the data located in the matching section to which comment is allocated, but it is not limited thereto.

In FIG. 4, comment 1 to comment 6 may be formed of characters or symbols, but may be a code assigned to the comment 1 to the comment 6 respectively.

Meanwhile, the processor 104 may receive a score for at least one of the setting section, the classification tag, and the comment from one or more user terminals and may allocate the score.

That is, a specific user may endow a score for the setting section made by other users, the classification tag, and the appropriacy of comment through the input unit 118 or a terminal. Scores for the setting section may be a score for query that contains information on the setting section.

In addition, the processor 104 may calculate the number of citations of comment when the comment is cited in other comment. For example, if comment 3 is ‘Take care depending on comment 1 when another matching section occurs within #one minute after a first matching section’, then, the comment 3 cites the comment 1 once.

Through this, the processor 104 may compute the price for comment depending on the score and the number of citations of the comment.

Accordingly, the data searching apparatus according to an embodiment of the present disclosure may provide an appropriate compensation to user who has written a corresponding comment.

The price is calculated according to the score and the number of citations of the comment in the above, but the price may be calculated according to the score for appropriately set setting section so that compensation may be provided to the user who set a corresponding setting section.

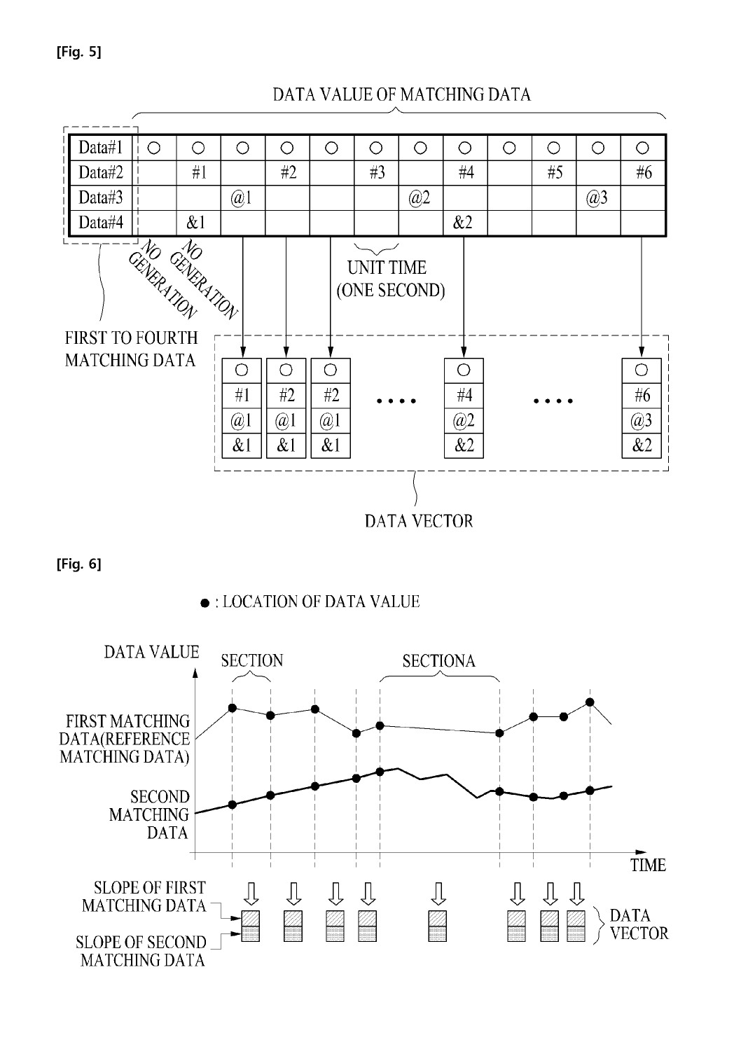

Meanwhile, the processor 104 may generate a data vector formed of a first feature of the first matching data and a second feature of the second matching data. FIG. 5 and FIG. 6 are diagrams illustrating a process for generating a data vector.

The process for generating a data vector of FIG. 5 is illustrated and then the process for generating a data vector of FIG. 6 is illustrated.

In FIG. 5, Data#1 to Data#4 are the first to the fourth matching data which are different from each other. At this time, the data generation cycle of each search target time-series data may be different from each other.

For example, the data of Data#1 may be generated every unit time (e.g., one second), the data of Data#2 may be generated every two seconds, and the data of Data#3 and Data#4 may be generated every four seconds and six seconds respectively. In the above description, it is assumed that unit time is one second, but it is not limited thereto, and may vary in some cases.

At this time, the first feature to the fourth feature of the first matching data the fourth matching data may be data value of each matching data. Data vector may be formed of this data value.

Data vector may be generated every unit time. However, as described above, since a data generation cycle of matching data may be different from each other, data value of first matching data may exist in a specific unit time, but data value of second matching data may not exist.

Since data vector is not generated if the data value of the matching data does not exist, it is possible to virtually generate a data value based on the set method.

For example, as shown in FIG. 5, if data value does not exist between n-th data value and (n+T)-th (n is one or more natural number, T is cycle) data value of each matching data, the processor 104 may virtually generate n-th data value to fill a gap between the n-th data value and (n+m)-th data value.

That is, since the n-th data value of the second matching data is #1 and T is 2, (n+2)-th(=n+T) data value is #2 and data value does not exist between n-th data value and (n+2)-th data value.

Accordingly, the processor 104 may virtually fill a gap between the n-th data value and (n+2)-th(=n+T) data value with #1(=n-th data value). The processor 104 may fill the data value of remaining third and fourth matching data in the same way.

As shown in FIG. 5, there may be a section in which data vector is not generated. When generating very first data vector, in the case of Data#2, past data is required as there is no data of present point. However, past data may not exist.

Since this phenomenon occurs even in the case of Data#3 in the first and second data vector, the first data vector and the second data vector may not be completely filled. Thus, the first data vector and the second data vector may not be generated.

Alternatively, empty data value may be filled by virtually generating an average value of the n-th data value and (n+T)-th data value, and data value may be virtually generated through various methods.

Accordingly, data vector may be generated every unit time.

Meanwhile, the processor 104 may generate data vectors by sampling a part of total data of the matching section. That is, the first feature and the second feature may be a data value sampled at the same point of time from the first matching data and the second matching data respectively. Data vector having reliability may be generated while reducing the amount of computation of the processor 104 according to the control of sampling rate.

Next, the method of generating a data vector is described with reference to FIG. 6.

As shown in FIG. 6, the first matching data and the second matching data which are different from each other may be indicated by a straight line connected to the display unit 114. At this time, the first feature of the first matching data and the second feature of the second matching data may include each slope of the segmented first matching data and second matching data existing in the same section.

The processor 104 may perform segmentation for the time-series data, the search target time-series data or the time-series data of matching data, and may use the Piecewise Linear Segmentation method. Such segmentation method is not limited to the Piecewise Linear Segmentation method, but various segmentation methods may be applied to the present disclosure.

Accordingly, the time-series data, the search target time-series data or the matching data may be formed of a segment of a straight line shape.

As shown in FIG. 6, the data vector may be generated for each section, and it should be decided whether the setting of section is achieved based on the first matching data or based on the second matching data.

In the case of the embodiment of the present disclosure, the processor 104 may set section based on the matching data that has more numbers of segment. Accordingly, more data vector may be generated in comparison with the case in which section is set based on the second matching data.

As shown in FIG. 6, since the number of segments of the first matching data is greater than the number of segments of the second matching data, reference matching data for setting section may be the first matching data.

The processor 104 may set the section whenever the slope of the segment forming the first matching data is changed, and may generate data vector through the slope of the first matching data and second matching data of each section.

At this time, in the section A, the number of segments of the second matching data is greater than the number of segments of the first matching data which is the reference matching data. Accordingly, a plurality of segment slopes may exist in the section A, and the processor 104 may set a representative slope representing the plurality of segment slopes in the section A to a second feature.

In an embodiment of the present disclosure, the representative slope may be an average value of a plurality of segment slopes, but it is not limited thereto, and the representative slope may be set by various methods.

In addition, the first feature and the second feature of the data vector may include data value in the section boundary together with the slope. In FIG. 6, the data value of black point may be data value in the section boundary.

The generation of data vector is not limited to the method shown in FIGS. 5 and 6 and data vector may be generated by various methods.

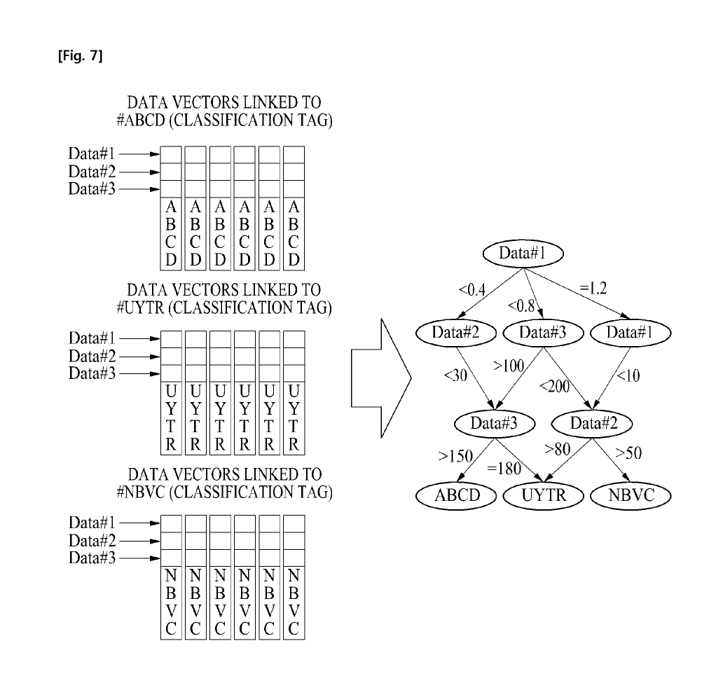

Meanwhile, machine learning model is described in detail with reference to FIG. 7 to FIG. 9.

As described above through FIGS. 5 and 6, data vector is generated in matching section, and comment including classification tag is allocated to matching section. Thus, as shown in FIG. 7, data vector may be linked to classification tag.

Machine learning model of FIG. 7 uses decision tree learning. That is, the relationship of Data#1, Data#2, Data#3 of the data vector linked to the classification tags #ABCD, #UYTR, #NBVC may be set as decision tree.

For example, as shown in FIG. 7, data vector linked to classification tag #ABCD may be Data#1<0.4, Data#2<30, and Data#3>150. Furthermore, in FIG. 7, there may be relation of Data#1, Data#2, Data#3 linked to classification tag #ABCD, but it is omitted.

In addition, data vector linked to classification tag #UYTR may be Data#1>0.8, Data#3>100, and Data#3=180. Furthermore, in FIG. 7, there may be relation of Data#1, Data#2, Data#3 linked to classification tag #UYTR, but it is omitted.

In addition, data vector linked to classification tags #NBVC may be Data#1=1.2, Data#1<10, and Data#2>50. Furthermore, in FIG. 7, there may be relation of Data#1, Data#2, Data#3 linked to classification tag #NBVC, but it is omitted.

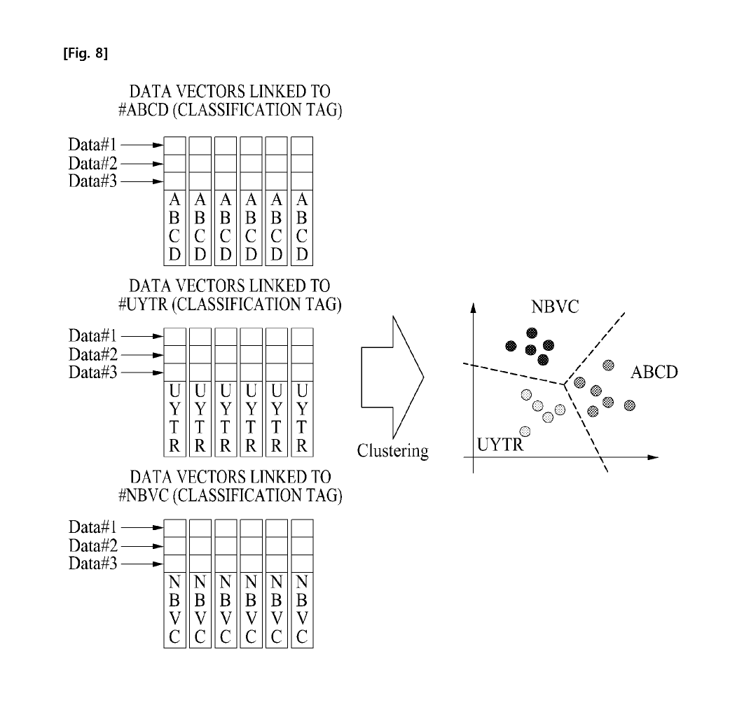

Meanwhile, the machine learning model of FIG. 8 uses clustering existing in a vector space.

That is, since data vectors linked to one classification tag may be more closely gathered in the vector space compared to data vectors linked to another classification tag, they may be clustered into one group.

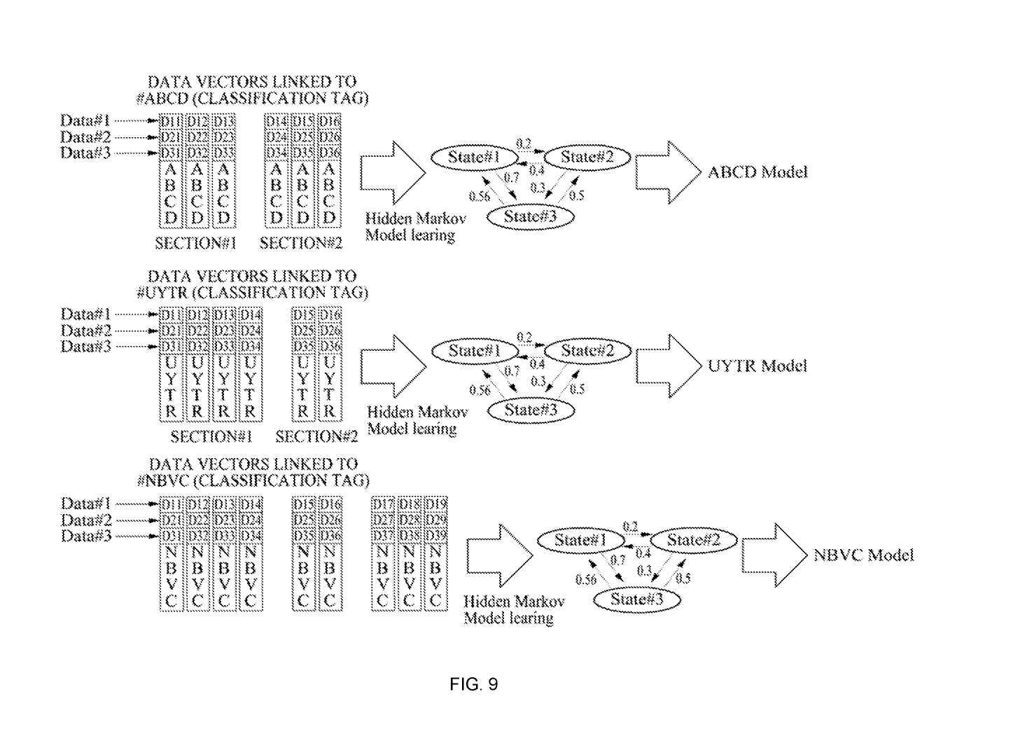

In addition, machine-learning model of FIG. 9 may be included in one classification tag and may be formed through relation between components of sequentially generated data vectors. Data vectors may be formed sequentially, and machine-learning may be achieved through state change between components of consecutive two data vectors.

For example, as shown in FIG. 9, data vectors included in classification tag #ABCD may be (D11, D21, D31), (D12, D22, D32), (D13, D23, D33), (D14, D24, D34), (D15, D25, D35), and (D16, D26, D36).

State change between D11 and D12, state change between D12 and D13, state change between D13 and D14, state change between D14 and D15, and state change between D15 and D16 may be calculated.

Calculation of the state change may be accomplished between D21 and D22, between D22 and D23, between D23 and D24, between D24 and D25, and between D25 and D26, and, similarly, may be accomplished between D31 and D32, between D32 and D33, between D33 and D34, between D34 and D35, and between D35 and D36.

The standard of state change may be variously set case by case. For example, if difference between consecutive two components is greater than 20, it may be set that state is changed from State#1 to State#2. If ratio between consecutive two components is greater than 1, it may be set that state is changed from State#2 to State#3. The standard of state change from State#2 to State#1, and the standard of state change from State#3 to State#1 may be set.

The ratio of the number of times for each state change to the number of times for a total state change may be calculated according to the standard of such state change, and such a ratio may become machine learning model.

The processor 104 may classify a first analysis target time-series data and a second analysis target time-series data according to classification tag by applying the first analysis target time-series data and the second analysis target time-series data to machine learning model in accordance with data vector.

That is, as shown in FIG. 7 to FIG. 9, various machine learning models may be generated according to classification tag, and the first analysis target time-series data and the second analysis target time-series data may be newly input to the data searching apparatus according to an embodiment of the present disclosure.

The processor 104 may classify a first analysis target time-series data and a second analysis target time-series data according to classification tag by applying newly input first analysis target time-series data and second analysis target time-series data to machine learning model.

That is, the processor 104 may apply a first analysis target time-series data and a second analysis target time-series data to machine-learning model without derivation of matching data and comment allocation. Accordingly, the first analysis target time-series data and the second analysis target time-series data may be classified by a specific classification tag.

Next, a data searching apparatus according to another embodiment of the present disclosure is described with reference to the drawing.

The data searching apparatus according to another embodiment of the present disclosure may include the memory 106 which stores time-series data, and the processor 104 which can access the memory 106.

The processor 104 may allocate comment input from the outside to partial section or partial time of time-series data, and may classify comment according to classification tag included in the comment.

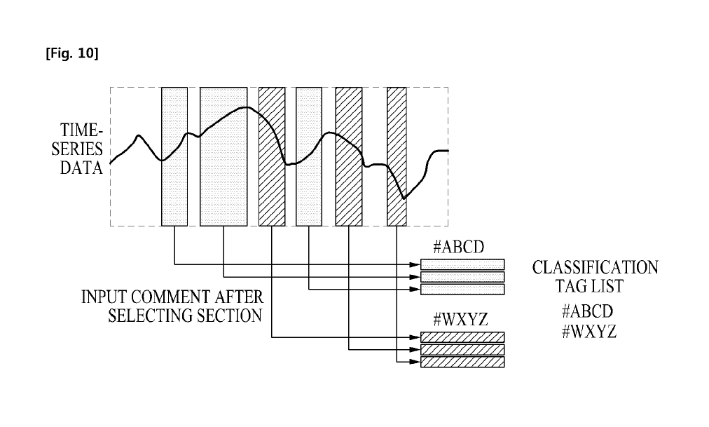

FIG. 10 to FIG. 12 illustrate a comment allocated to a section selected by a user.

As shown in FIG. 10, user may input comment to a section of time-series data selected by user itself via the input unit 118 or a terminal. Accordingly, the processor 104 may allocate the input comment to the section selected by user.

At this time, the comment may include classification tag, and the processor 104 may generate a classification tag list. Since the classification tag list is described in detail in the above, an explanation thereof is omitted.

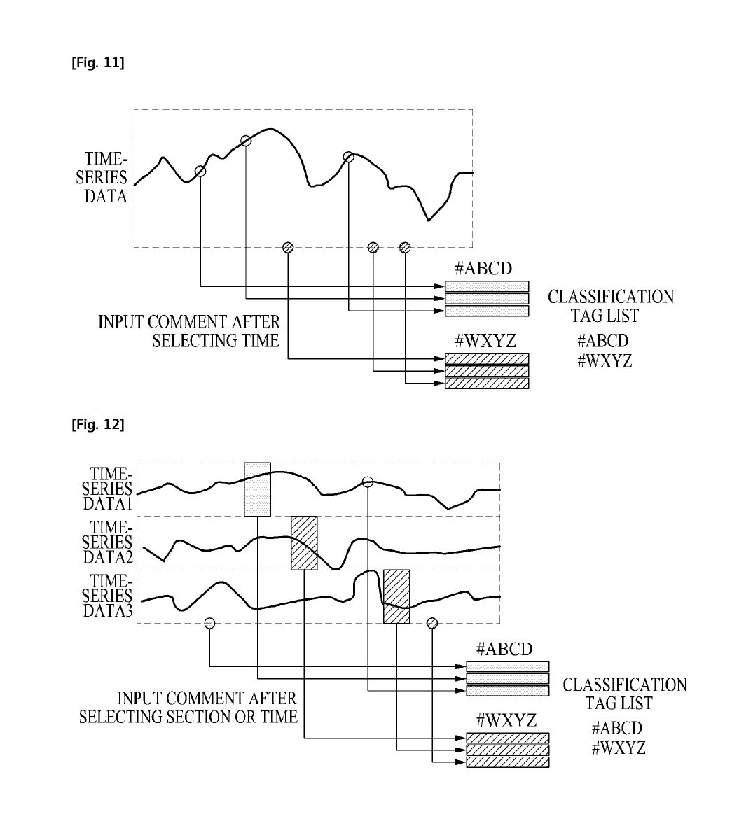

Comment is allocated to a selected section in FIG. 10, but, as shown in FIG. 11, comment may be allocated to a selected time. In addition, comments may be classified according to classification tag included in the comment, and classification tag list may be generated.

Furthermore, as shown in FIG. 12, comment may be allocated to at least one of the selected section or the selected time, comment may be classified according to classification tag allocated to the comment, and classification tag list may be generated.

That is, as shown in FIGS. 10 to 12, the processor 104 may generate a comments list on comment and may link to classification tag, and may generate a classification tag list for the classification tag.

User may drag a mouse, a stylus or a touch-screen of a terminal to select a certain section or a specific time of specific time-series data, and may write and store comment for a corresponding section.

The processor 104 may receive and allocate a score for at least one of classification tag and comment from one or more user terminals, and may calculate the number of citations of comment when the comment is cited in other comment.

Accordingly, the processor 104 may compute the price for comment according to the score and the number of citations of comment.

Since this is described above through the data searching apparatus according to an embodiment of the present disclosure, an explanation thereof is omitted.

Meanwhile, the processor 104 may generate data vector formed of feature of time-series data to which comment is allocated, and may apply another time-series data to the machine learning model in accordance with data vector to classify another time-series data by the classification tag.

Since this is described above in detail through the data searching apparatus according to an embodiment of the present disclosure, an explanation thereof is omitted.

Meanwhile, the processor 104 may apply still another time-series data to the machine learning model without comment allocation. Since this is described above in detail through the data searching apparatus according to an embodiment of the present disclosure, an explanation thereof is omitted.

The machine learning model described above also may be evaluated by users and the score for machine learning model may be allocated by the processor 104, and the processor 104 may compute the price for machine learning model according to the score for the machine learning model.

The processor 104 may control the process of trading the machine learning model which has computed the price, and, if the machine learning model is sold, may also control the compensation process for the user who has built the machine learning model.

The data searching apparatus according to an embodiment of the present disclosure may search data desired by user by searching a part which is identical with or similar to pattern corresponding to setting section in a plurality of different time-series data from search target time-series data.

The data searching apparatus according to an embodiment of the present disclosure may classify comment allocated to matching section by allocating comment that includes classification tag.

The data searching apparatus according to an embodiment of the present disclosure may compute the price according to the score in accordance with the adequacy of comment, setting section, and classification tag list or the number of citations of comment.

The data searching apparatus according to an embodiment of the present disclosure may classify analysis target time-series data that is newly input through the machine learning model according to classification tag.

The data searching apparatus according to an embodiment of the present disclosure may compute the price according to the score in accordance with the adequacy of comment, selection section, selection time, and classification tag list or the number of citations of comment.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A data searching apparatus comprising:
a memory configured to store a first time-series data and a second time-series data which are different from each other; and
a processor configured to be able to access the memory,
wherein the processor derives a first matching data which is a part of a first search target time-series data that is matched to a first pattern of the first time-series data existing in a setting section, and derives a second matching data which is a part of a second search target time-series data, which is different from the first search target time-series data, that is matched to a second pattern of the second time-series data existing in the setting section.

2. The data searching apparatus of claim 1, wherein the first search target time-series data and the second search target time-series data are at least part of the first time-series data and the second time-series data respectively.

3. The data searching apparatus of claim 1, wherein the first search target time-series data and the second search target time-series data are different from the first time-series data and the second time-series data.

4. The data searching apparatus of claim 1, wherein the processor allocates an externally input comment to a matching section in which the first matching data and the second matching data exist, and classifies the comment according to classification tag included in the comment.

5. The data searching apparatus of claim 4, wherein the processor generates a comment list for the comment to link to the classification tag, and generates a classification tag list for the classification tag.

6. The data searching apparatus of claim 4, wherein the processor receives and allocates a score for at least one of the setting section, the classification tag, and the comment from one or more user terminals, calculates the number of citations of the comment when the comment is cited in other comment, and computes a price for the comment according to the score and the number of citations of the comment.

7. The data searching apparatus of claim 4, wherein the processor generates a data vector formed of a first feature of the first matching data and a second feature of the second matching data, and classifies the first analysis target time-series data and the second analysis target time-series data according to the classification tag by applying the first analysis target time-series data and the second analysis target time-series data to machine learning model in accordance with the data vector.

8. The data searching apparatus of claim 7, wherein the processor applies the first analysis target time-series data and the second analysis target time-series data to the machine learning model without a derivation of matching data and a comment allocation.

9. The data searching apparatus of claim 7, wherein the first feature and the second feature are a data value sampled at the same point of time from the first matching data and the second matching data respectively.

10. The data searching apparatus of claim 7, wherein the first feature and the second feature include each slope of the segmented first matching data and second matching data existing in the same section.

11. A data searching apparatus comprising:
a memory configured to store a time-series data; and
a processor configured to be able to access the memory,
wherein the processor allocates an externally input comment to a partial section or partial time of the time-series data, and classifies the comment according to classification tag included in the comment.

12. The data searching apparatus of claim 11, wherein the processor generates a comment list for the comment to link to the classification tag, and generates a classification tag list for the classification tag.

13. The data searching apparatus of claim 12, wherein the processor receives and allocates a score for at least one of the classification tag and the comment from one or more user terminals, calculates the number of citations of the comment when the comment is cited in other comment, and computes a price for the comment according to the score and the number of citations of the comment.

14. The data searching apparatus of claim 11, wherein the processor generates a data vector formed of feature of the time-series data to which the comment is allocated, and classifies another time-series data by applying the another time-series data to machine learning model in accordance with the data vector.

15. The data searching apparatus of claim 14, wherein the processor applies the another time-series data to the machine learning model without a comment allocation.
